(19) United States
(12) Patent Application Publication
(10) Pub. No.: US 2009/0022862 A1
(43) Pub. Date: Jan. 22, 2009

(54) Method to limit acrylamide in heated foods

(75) Inventors: Rudolf Fluckiger, Brookline, MA (US); Erdjan Salih, Plymouth, MA (US)

Correspondence Address: DAVID S. RESNICK, NIXON PEABODY LLP, 100 SUMMER STREET, BOSTON, MA, 02110-2131, US

(73) Assignee: Children's Medical Center Corporation, Boston, MA (US)

(21) Appl. No.: 11/659,252

(22) PCT Filed: Aug. 3, 2005
(86) PCT No.: PCT/US05/27463

§ 371 Date: Feb. 6, 2008

Related U.S. Application Data
(60) Provisional application No. 60/598,248, filed on Aug. 3, 2004.

(51) Int. Cl. A23L 3/3454

(52) U.S. Cl. 426/309; 426/310

(57) ABSTRACT

The present invention provides a method for reducing the level of acrylamide in a food product, comprising: (a) applying an acrylamide reduction agent in alkaline solution onto a food material before heat treating the food material; and (b) heat treating the food material to form the finished food product, wherein due to application of the thiol agent in alkaline solution, the finished food product comprises reduced level of acrylamide compared to a product which has not been treated with the acrylamide reduction agent in alkaline solution before heating. In addition, the present invention provides a food production produced by the method of the present invention.

### RELATED APPLICATIONS

This application claims the benefit under 35 U.S.C. § 119(e) of the U.S. Provisional Application Ser. No. 60/598,248, filed on Aug. 3, 2004, the entire contents of which are incorporated herein by reference.

### FIELD OF THE INVENTION

The present application provides methods for limiting acrylamide in foods, particularly starchy foods.

### BACKGROUND OF THE INVENTION

Today, carbohydrate-containing foods such as breads, breakfast cereals, biscuits, crackers, cookies, french fries, cooked starchy vegetables, taco shells, and snack foods are popularly consumed. Although such foods have been part of the human diet for countless years, researchers have only recently discovered that many of these foods contain acrylamide.

In April 2002, the Swedish National Food Administration and researchers from Stockholm University announced their findings that acrylamide, a potentially cancer-causing chemical, is formed in many types of cooked foods. Acrylamide has a carcinogenic potency in rats that is similar to that of other carcinogens in food. The cancer risk associated with lifelong intake of 1 μg acrylamide/kg body weight per day has been estimated to range from 700-10,000 additional cancers per million (von Muhlendahl et al. Eur. J Pediatr 2003, 162, 447-448). Some subjects may be at a higher risk, i.e. those with increased acrylamide activation, unborn and young children exposed to acrylamide that passes across the placenta and appears in breast milk (Sörgel et al. Chemotherapy 2002, 48, 267-274), or subjects with particular dietary habits. At higher doses acrylamide is neurotoxic.

It would be desirable to have a method of reducing acrylamide levels in foods.

### SUMMARY OF THE INVENTION

The present invention is directed to a method to reduce the level of acrylamide in food products. It is also an object of the present invention to provide food products having reduced levels of acrylamide.

The present invention provides a method for reducing the level of acrylamide in a food product, comprising: (a) applying an acrylamide reduction agent in alkaline solution onto a food material before heat treating the food material; and (b) heat treating the food material to form the finished food product, wherein due to application of the thiol agent in alkaline solution, the finished food product comprises reduced level of acrylamide compared to a product which has not been treated with the acrylamide reduction agent in alkaline solution before heating.

In one embodiment, the alkaline solution has a pH above pH 7. In another embodiment, the alkaline solution has a pH of about 8.0 to about 13.0.

In one embodiment, the acrylamide reduction agent is compound containing a sulfhydryl group, e.g. a thiol group. In one preferred embodiment, the acrylamide reduction agent is cysteine or glutathione.

In one embodiment, the alkaline solution is phosphate buffer. In one preferred embodiment, the alkaline solution is 1% dibasic sodium phosphate (pH 9.1).

In one embodiment, the alkaline solution is carbonate buffer (pH 9.2-pH 10.8). In one embodiment, the alkaline solution is glycine/sodium hydroxide solution (pH 9.2-pH 10.8).

In one preferred embodiment, acrylamide reduction agent is applied to the surface of the food product.

In one embodiment, the food product is selected from the group consisting of crackers, breads, toaster pastries, cookies, danish, croissants, tarts, pie crusts, pastries, muffins, brownies, sheet cakes, donuts, snack foods, flours, mixes, refrigerated doughs, frozen foods, bagels, breakfast cereals, biscuits, French fries, vegetables, taco shells, flour and corn tortillas, corn masa, hash browns, mashed potatoes, potato chips, processed potatoes, toast, grilled sandwiches, crepes, wontons, dumplings, pancakes, waffles, batters, pizza crust, rice, nut-based foods, fruit, coffee beans, cocoa beans, hush puppies, alcoholic beverages, meat products, and animal foods.

### BRIEF DESCRIPTION OF THE DRAWINGS

FIG. 1 shows a scheme of acrylamide formation, metabolic activation and trapping with cysteine. * C—N bond cleft by heat.

FIGS. 2A-2B show detection by liquid chromatography-mass spectrometry (LC/MS) of acrylamide dimer (FIG. 2A) and acrylamide-cysteine adduct (FIG. 2B) in heated aqueous reaction mixtures containing equimolar amounts of: (FIG. 2A) glucose and asparagine or, (FIG. 2B) glucose, asparagine and cysteine hydrochloride. FIG. 2A shows that acrylamide elutes as dimer at 1.276 min; m/z 143 (2M+H) and m/z 165 (2M+Na) (inset). FIG. 2B shows that the cysteine adduct of acrylamide elutes at 3.32 min as confirmed by post source decomposition (PSD-MS) (inset).

FIG. 3 shows the acrylamide content of crust and soft bread with and without pretreatment of dough.

### DESCRIPTION OF THE INVENTION

The present invention is based on the discovery that acrylamide as found in heat treated food products may be trapped by a sulfhydryl containing compound (for example, cysteine) and thus the levels of acrylamide in food reduced. The present invention is further based on the discovery that the sulfyhdryl group of cysteine, or other suitable sulfhydryl compound, reacts with the alkene double bond (C═C) in acrylamide under alkaline pH.

The present invention provides methods for reducing the levels of acrylamide in heat treated food products comprising application of basic aqueous solution, for example cysteine in aqueous alkaline solution or other sulfhydryl compounds in aqueous alkaline solution, on the food product prior to heating of said food product. Preferably, the solution is applied to the surface of the food product.

### DEFINITIONS

As used herein, the term “acrylamide reduction agent” refers to a compound or agent that when added to a food product causes a reduction in levels of acrylamide of the food product as compared to the food product when prepared without addition of the compound or agent. Preferably, the level of acrylamide in the finished food product is reduced by at least about 10%, preferably at least about 20%, preferably at least about 30%, preferably at least about 40%, more preferably at least about 50%, preferably at least about 60%, still more preferably at least about 70%, preferably at least about 80%, and even more preferably at least about 90%.

As used herein, “heat treated” or “thermally processed,” refers to exposing the food material to a temperature of at least 80° C., 100° C., 120° C., 150° C., 180° C., 190° C., 200° C. or 210° C. Examples of heat treating in a food preparation process include but are not limited to frying, baking, roasting, steaming, boiling and high temperature extrusion. The present invention can be practiced with any food material (including animal food material) that undergoes heat treating which can lead to the formation of acrylamide.

As used herein, “heat treated” or “thermally processed,” also refers to conditions wherein components of the food, such as a mixture of food ingredients, are heated at temperatures of at least 80° C. Preferably the thermal processing of the food or food ingredients takes place at temperatures between about 100° C. and 205° C. The food ingredient may be separately processed at elevated temperature prior to the formation of the final food product. An example of a thermally processed food ingredient is potato flakes, which is formed from raw potatoes in a process that exposes the potato to temperatures as high as 170° C. (The terms “potato flakes”, “potato granules”, and “potato flour” are meant to denote any potato based, dehydrated product.) Alternatively, raw food ingredients can be used in the preparation of the final food product wherein the production of the final food product includes a thermal heating step. One example of raw material processing wherein the final food product results from a thermal heating step is the manufacture of potato chips from raw potato slices by the step of frying at a temperature of from about 100° C. to about 205° C. or the production of french fries fried at similar temperatures.

### Food Products

As used herein a food product and/or food intermediate may include an additive, component, supplement or ingredient useful in preparing or supplementing a food, or a food intermediate, a fully prepared composition but in a raw state (requiring a further treatment step prior to consumption, such as baking dough to produce bread) or a finished food product that is ready to eat. Food products and food intermediates as provided hereunder generally include any food products or food intermediates derived from or containing grain, cereal or vegetable based components. Food products may also include nutritional beverages and energy drinks.

The food to which the method of the present invention can be applied is not particularly limited as far as, when the additive of the invention is not used, acrylamide is generated by the cooking under heat. The method herein can be used in the production of any suitable food product, including but not limited to carbohydrate-containing foods that are heated, such as baked or fried during preparation and food materials containing high levels of asparagine or both. Carbohydrate-containing foods include but are not limited to those prepared from potato or potato-based materials, sweet potato or sweet potato-based materials, grain (e.g., wheat, oat, rye, corn and rice) or grain-based materials, and meat products that contain starch. In addition, potatoes, sweet potatoes, grains and the like are often processed into doughs, batters and mash. From these doughs, batters and mash, products such as crackers, breads, quick-breads, cookies, chips, breakfast cereals and the like can be produced, as can deep-fried foods and extruded foods, such as snack foods.

Although the method herein will generally be described in terms of preferred bread products, it should be understood by one skilled in the art that the method herein can be applied to any suitable food product. Non-limiting examples include crackers, breads (e.g., rye, wheat, oat, potato, white, whole grain products, mixed flours, loaves, twists, buns, rolls, pitas, matzos, focaccia, melba toast, zwieback, croutons, soft pretzels, soft and hard bread sticks, heat and serves), toaster pastries, cookies, danish, croissants, tarts, pie crusts, pastries, muffins, brownies, sheet cakes, donuts, snack foods (e.g., pretzels, tortilla chips, corn chips, potato chips, fabricated snacks, fabricated potato crisps, extruded snacks, extruded filled snacks, trail mix, granola, snack mixes, L shoe-string potatoes), flours, mixes (e.g., cake mixes, biscuit mixes, brownie mixes, bread mixes, pancake mixes, crepe mixes, batter mixes, pizza dough), refrigerated doughs (e.g., biscuits, breads, bread sticks, croissants, dinner rolls, pizza dough, cookies, danish, brownies, pie crust), frozen foods (e.g., pie crusts, pies, tarts, turnovers, pizzas, food pockets, cakes, French fries, hash browns, processed potatoes, breaded products such as chicken and fish, breaded vegetables), noodles, pasta, wrapped foods (e.g. wontons, crepes, dumplings), bagels, breakfast cereals, biscuits, French fries, vegetables (e.g., dried, grilled, roasted, broiled, fried, vacuum dried), corn masa, taco shells, soy products, processed oats, hash browns, mashed potatoes, toast, grilled sandwiches, flour and corn tortillas, crepes, pancakes, waffles, batters, pizza crust, rice (including dried and par-boiled), nut-based foods (e.g., peanut butter, foods containing chopped nuts), fruit (e.g., dried, grilled, roasted, broiled, fried, vacuum dried, baked, jellies, pie fillings, flambes, raisins, cranberries, cherries), coffee beans, products containing roasted cocoa beans, hush puppies, alcoholic beverages (e.g., beers and ales), meat products containing starch or grain-based materials (e.g. hamburger, fried chicken, breaded chicken, breaded fish or breaded meat), foods containing asparagine (e.g. sweet potatoes, onions and other vegetables), and animal foods (e.g., dog food, cat food).

### Acrylamide Reduction Agents

In one embodiment of the present invention, the level of acrylamide in a food product is reduced by applying an agent containing a suflhydryl group having an alkaline pH (e.g. a thiol-containing agent in alkaline aqueous solution) to the food product. Preferably, the thiol-containing agent is cysteine or glutathione. Nonlimiting examples of thiol containing compounds include thioglycolic acid, thioethylene glycol, thioglycerol, thioethanol, thioactic acid, thiosalicylic acid and salts thereof (e.g., calcium, sodium, strontium, potassium, ammonium, lithium, magnesium, and other metal salts).

In an alternative embodiment, amino acids (e.g. in basic solution, in basic aqueous solution) are applied to the food product in order to reduce acrylamide levels. Nonlimiting examples of thio-containing amino acids or their derivatives include L-cysteine, D-cysteine, DL-cysteine, N-acetyl-L-cysteine, DL-homocysteine, N-carbamoyl cysteine, glutathione, and cysteamine, and salts and esters thereof (e.g., methyl and ethyl esters).

In an alternative embodiment, the level of acrylamide. in a food product is reduced by applying an agent containing an amino group and having an alkaline pH to the food product.

In one preferred embodiment, the acrylamide reduction agent is applied in a solution of 1 gram acrylamide reduction agent per 10 milliliters of solution. Alternatively, the acrylamide reduction agent may be applied in a solution of about 0.1 g/10 ml to about 5 g/10 ml.

The acrylamide reduction agent may be prepared in an alkaline solution. The alkaline solution may be any alkaline aqueous solution or buffer appropriate for the dissolution of the acrylamide reduction agent and for consumption subsequent to the production of the food material by the methods of the present invention by humans or other intended consumers of the food product (e.g. mammals, birds). In one embodiment, the alkaline buffer has a pH above pH 7.0. In another embodiment, the alkaline buffer has a pH of about 8.0-13.0. In another embodiment, the alkaline buffer has a pH of about 8.5-12.5. In yet another embodiment, the alkaline buffer has a pH of about 9.0-12.0. In yet another embodiment, the alkaline buffer has a pH of about 9.5-11.5.

The acrylamide reduction agent may be prepared in a carbonate buffer solution having a pH of about 9.1-10.9. In one embodiment, the carbonate buffer has a pH of about 9.0-10.8. In another embodiment, the carbonate buffer has a pH of about 8.9-10.7. In another embodiment, the carbonate buffer has a pH of about 8.8-10.6. In another embodiment, the carbonate buffer has a pH of about 8.7-10.5. In yet another embodiment, the carbonate buffer has a pH of about 8.8-10.4. In yet another embodiment, the carbonate buffer has a pH of about 8.9-10.3. In yet another embodiment, the carbonate buffer has a pH of about 9.0-10.2. In yet another embodiment, the carbonate buffer has a pH of about 9.1-10.1. In yet another embodiment, the carbonate buffer has a pH of about 9.2-10.0. In yet another embodiment, the carbonate buffer has a pH of about 9.3-9.9. In yet another embodiment, the carbonate buffer has a pH of about 9.4-9.7.

Alternatively, the acrylamide reduction agent may be prepared in a glycine/sodium hydroxide buffer having a pH of about 8.5-12.9. In one embodiment, the glycine/sodium hydroxide buffer has a pH of about 8.6-12.8. In one embodiment, the glycine/sodium hydroxide buffer has a pH of about 8.8-12.6. In another embodiment, the glycine/sodium hydroxide buffer has a pH of about 9.0-12.4. In another embodiment, the glycine/sodium hydroxide buffer has a pH of about 9.2-12.2. In yet another embodiment, the glycine/sodium hydroxide buffer has a pH of about 9.4-12.0. In yet another embodiment, the glycine/sodium hydroxide buffer has a pH of about 9.6-11.8. In yet another embodiment, the glycine/sodium hydroxide buffer has a pH of about 9.8-11.6. In yet another embodiment, the glycine/sodium hydroxide buffer has a pH of about 10.0-11.4. In yet another embodiment, the glycine/sodium hydroxide buffer has a pH of about 10.2-11.2. In yet another embodiment, the glycine/sodium hydroxide buffer has a pH of about 10.4-11.0. In yet another embodiment, the glycine/sodium hydroxide buffer has a pH of about 10.6-10.8.

Alternatively, the acrylamide reduction agent is prepared in a phosphate solution. Preferably, the acrylamide reduction agent is prepared in a dibasic phosphate solution. Preferably, the dibasic phosphate solution is dibasic potassium phosphate. Preferably, the dibasic phosphate solution is dibasic sodium phosphate. The dibasic phosphate buffer may comprise about 0.1% to about 10% dibasic phosphate. The dibasic phosphate buffer may have a pH of about 8.0 to about 10.0. In one preferred embodiment, the buffer is 1% dibasic sodium phosphate having pH 9.1.

Since the acrylamide reduction agents of the present invention are used in a food, it is needless to say, that preferable acrylamide reduction agents and preferable buffers for the acrylamide reduction agents are not only selected from those having an enhanced ability of lowering the acrylamide of the cooked food, but also are selected in view of, for example, the solubility to water, color, taste, odor, toxicity and cost in accordance with the food to which the additives are added.

### Application of the Acrylamide Reduction Agent

In the method of the present invention, the method of applying the acrylamide reduction agent to the food is not particularly limited. In a preferred embodiment, the acrylamide reduction agent is applied prior to heating. Any method known to those of skill in the art for applying the acrylamide reduction agent to the food product may be used. It is possible to select appropriately the method of applying the acrylamide reduction agent in accordance with the state of the food to which the acrylamide reduction agent is applied and in accordance with the preparation process. For example, where the food, to which the acrylamide reduction agent is applied, is a solid material like potatoes used for the preparation of potato chips, or a semi-solid material or a material having high fluidity such as a bread dough, a noodle dough or a dough for the baked confectionery, it is possible to apply the acrylamide reduction agent to the food by means showering, spraying, dipping, brushing, rolling, dropping a film, coating or any combination of these. The number of applications is not limited; it is possible to add the additive only once or a plurality of times during the preparation process. The acrylamide reduction agent may also be applied by machines.

The food to which the method of the present invention is applied may be cooked in a conventional method, except that the acrylamide reduction agent of the present invention is added to the food before the cooking under heat.

The timing at which the acrylamide reduction agent is added to the food is not particularly limited as far as the acrylamide reduction agent is added before the heat treatment or thermal processing. It is possible to add the acrylamide reduction agent at an appropriate timing during the heat treatment of the food.

When a food is to be coated with one or more surface additives (e.g. seasoning, sugar coating, egg wash, crisping and browning agents), the acrylamide reduction agent may be applied to the food material together with the surface additive. Alternatively, the acrylamide reduction agent may be applied prior to application of the surface additives or subsequent to the application of the surface additives.

For baked confectionery such as cookies, the acrylamide reduction agent may be coated during the molding process.

In another variation, the dough may be extruded under conditions of temperature and pressure so as to puff and expand (the “direct expansion” technique) and is sectioned or cut into individual pieces to form individual expansions, e.g., puffed Ready-To-Eat cereal or snack pieces. The cooked dough can be puffable such as by deep fat frying, microwave heating, gun puffing, jet zone heating, etc. to prepare snack products. The acrylamide reduction agent can be applied at any point during the extruded food material preparation process, as long as the application occurs prior to a heat treatment step.

The acrylamide reduction agent may be applied to so-called “semi-cooked foods” or “par-baked foods”, i.e., partially cooked food before the final cooking under heat. Semi-cooked foods include food to which cutting and molding, etc., has been applied, as required, but cooking under heat has not yet been applied, and food to which cutting and molding, etc., has been applied, as required, and a preliminary cooking under heat has also been applied. Previously baked products or par-baked products that are partly baked are typically frozen or refrigerated. The acrylamide reduction agent or the acrylamide reduction agent in combination with other food additive, for instance a butter flavored oil to add additional taste to the intermediate, may be applied to the food material and then partially baked (“par-baked”). Alternatively, the intermediates may be stored in a refrigerated or frozen state prior to use and then the acrylamide reduction agent is applied prior to the final heat treatment, e.g. baking, to reduce acrylamide levels in the final product.

In the method of the present invention, it is possible to set the heating temperature and time for the heating at those applied in general to the food to which the present invention is applied. The method of the present invention is applied to the case where acrylamide is generated by cooking under heat that is carried out to the food. The temperature at which acrylamide is generated during the heating of the food is said to be relatively high, i.e., about 120° C. or higher. In the cooking of the food under heat, such a temperature condition arises, in general, during frying, which is generally carried out at 120 to 200° C., and during baking within an oven, which is generally carried out at 130 to 280° C., though the cooking process during which acrylamide generates is not limited to the frying and the baking pointed out above. It should be noted that the amount of acrylamide generated during the cooking is generally said to be increased with increase in the heating time.

In the method of the present invention, the amount of the acrylamide reduction agent is not particularly limited as far as the amount of acrylamide contained in the food cooked under heat, to which the acrylamide reduction agent is applied, is reduced compared with the case where the acrylamide reduction agent of the present invention is not applied to the food. The amount of the acrylamide reduction agent may be decided appropriately depending on the kind of the food to which the acrylamide reduction agent is applied, the heating temperature and the heating time for the cooking, the kind of the acrylamide reduction agent, the solubility of the acrylamide reduction agent, and the effect of decreasing acrylamide of the food after the cooking under heat. In view of the effect of decreasing acrylamide of the food after cooking under heat, it is desirable for the acrylamide reduction agent to be used in a large amount. However, where the acrylamide reduction agent itself has a taste and/or a color, it is desirable to determine the amount of the additive in view of, for example, the balance with the capability of maintaining the quality as the food. It is practical to use the additive in an amount of 0.01 to 5% by weight based on the amount of the raw material.

The present invention further includes a food product produced by the methods of the present invention.

It is understood that the foregoing detailed description and the following examples are illustrative only and are not to be taken as limitations upon the scope of the invention. Various changes and modifications to the disclosed embodiments, which will be apparent to those skilled in the art, may be made without departing from the spirit and scope of the present invention. Further, all patents, patent applications and publications cited herein are incorporated herein in their entirety by reference.

### EXAMPLE 1

### Limiting Acrylamide in Heated Starchy Foods by Cysteine-Acrylamide Adduct Formation

### Materials and Methods

Adduct formation in solution: Acrylamide was generated as described (11) by reacting equimolar amounts of glucose and asparagine in phosphate buffered saline, pH 7.4, in sealed thick-walled ampules for 1 hour at 180° C. Cysteine, added as hydrochloride, was included at the same concentration (0.1-0.2 mM) as the other reactants. Reaction mixtures were analyzed for acrylamide by reversed-phase high-performance liquid chromatography (RP-HPLC) using UV detection at 220 nm as described (21). For analysis by mass spectrometry, reaction mixtures were concentrated in a Vacufuge (Eppendorf) and suspended in a small volume of H₂O/0.1% trifluoroacetic acid.

Mass Spectrometric Analysis:

(1) Qualitative LC/MS was performed on a Micromass LCT time-of-flight mass spectrometer using a C18 Genesis column (4 μm, 2.1×150 mm). Compounds were eluted isocratically with 80% A/20% B (solvent A: H₂O+0.1% formic acid; solvent B: acetonitrile+0.1% formic acid) for 16 minutes with the mass sensitive detector set for the scan range 70-300 Da.

(2) MALDI-TOF MS: The identity of the putative S-(2-carboxyethyl)cysteine was evaluated by matrix-assisted laser-desorption/ionization time-of-flight mass spectrometry (MALDI-TOF MS) using post source decay (PSD) mode. A 1-μl sample was mixed with 1 μl CHCA (α-cyano-hydrocinnamic acid) matrix and spectra collected for the mass range 50-250 Da, with mass gauge off.

(3) Quantitative LC/MS: Acrylamide determinations in bread samples prepared as described below were performed according to the USDA reference method (22) by COVANCE Laboratories, Madison, Wis. The general limit of quantitation of this method is 10 ppb (1), values below that range represent estimates.

Test bread preparation: Dough was prepared from unbleached all-purpose flour, containing no added chemicals, with yeast, water and salt. Baking was for 50 minutes at 350° C. Cysteine hydrochloride was either admixed (0.02%; w), or painted onto the dough at 1 g/10 ml in 1% dibasic sodium phosphate (pH 9.1). Alternatively, 1% monobasic sodium phosphate (pH 4.5) was painted onto the dough for acidification, with water serving as control. The thiol agent cysteine hydrochloride and phosphate salts were chosen because these chemicals are already used safely in the preparation of foods. For analysis crust and soft bread were separated and finely powdered.

### Introduction

The finding of acrylamide levels of up to 3 mg/kg in some starchy foods prepared at high temperature such as bread, potato chips, fries, biscuits or cereals (1) has caused concern, as acrylamide has carcinogenic properties (2). The carcinogenic action of acrylamide is caused by its epoxy metabolite glycidamide (3). Glycidamide which is formed by cytochrome P450 2E1 is DNA reactive, and alkylates primarily guanine bases at N-7 (4). The cancer risk associated with lifelong intake of 1 μg acrylamide/kg body weight per day has been estimated to range from 700-10,000 additional cancers per million (5). However, a retrospective epidemiological study could not find an increased risk for cancer of the bowel, bladder, or kidney (6), possibly because the number of cases studied was not sufficient to document this additional risk (7). On the other hand, some subjects may be at a higher risk, i.e. those with increased acrylamide activation, unborn and young children exposed to acrylamide that passes across the placenta and appears in breast milk (8), or subjects with particular dietary habits. At higher doses acrylamide is also neurotoxic, possibly because of a direct action on the motor protein kinesin and microtubules (9), or on presynaptic thiol-containing proteins (10). In view of this evidence that acrylamide intake may be harmful to man, means are being sought to reduce acrylamide in heat-processed foods.

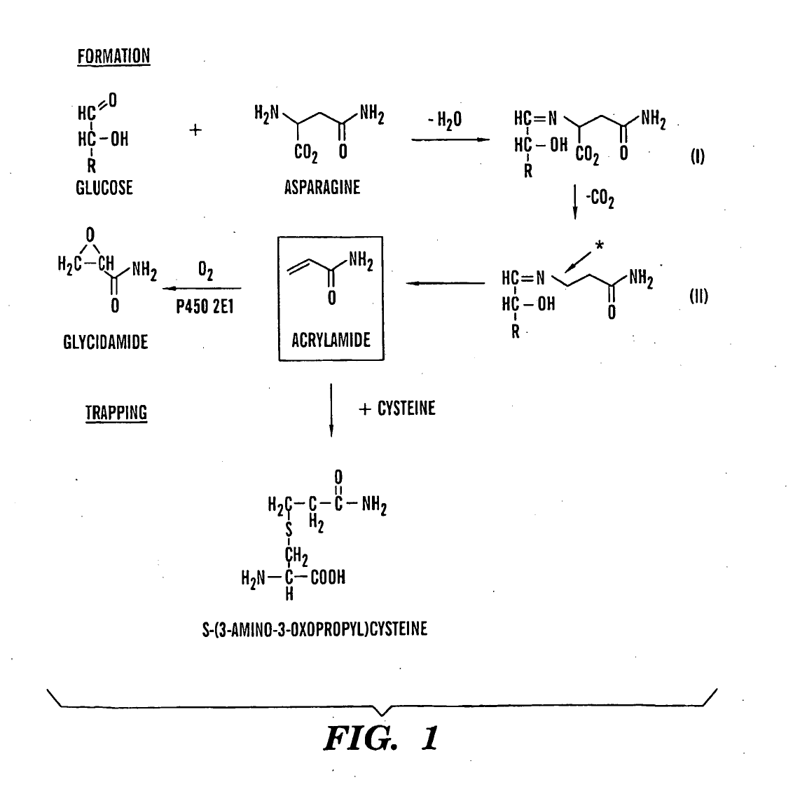

Acrylamide is formed in the Maillard reaction when starchy foods are heated above 120° C., from the Schiff base adduct between asparagine and reducing carbohydrates by decarboxylation/fragmentation (11-13) (FIG. 1). Acrylamide is released at high temperatures from the decarboxylated Schiff base intermediate by C—N bond cleavage (13). Its formation, therefore depends on the content of reducing carbohydrate(s) and asparagine (14), as well as the pH and temperatures encountered during heating (15).

In principle acrylamide formation could be minimized by limiting the formation of the Schiff base or its decomposition to acrylamide, but prevention of these reaction steps is not practical. Our hypothesis and strategy we investigated was whether acrylamide, once formed, would react with cysteine, thereby preventing accumulation of toxic free acrylamide. This approach appeared promising as acrylamide, under physiological conditions, reacts with sulfhydryl and to a lesser extent also the NH₂-terminal amino groups in hemoglobin (16; 17), a fact that rendered acrylamide-modified hemoglobin a biomarker of acrylamide exposure (16-19). We chose to investigate the formation of acrylamide and our strategy to prevent its formation in the making of oven baked crisp bread, a universal and basic foodstuff and major source of dietary acrylamide (20).

### Results

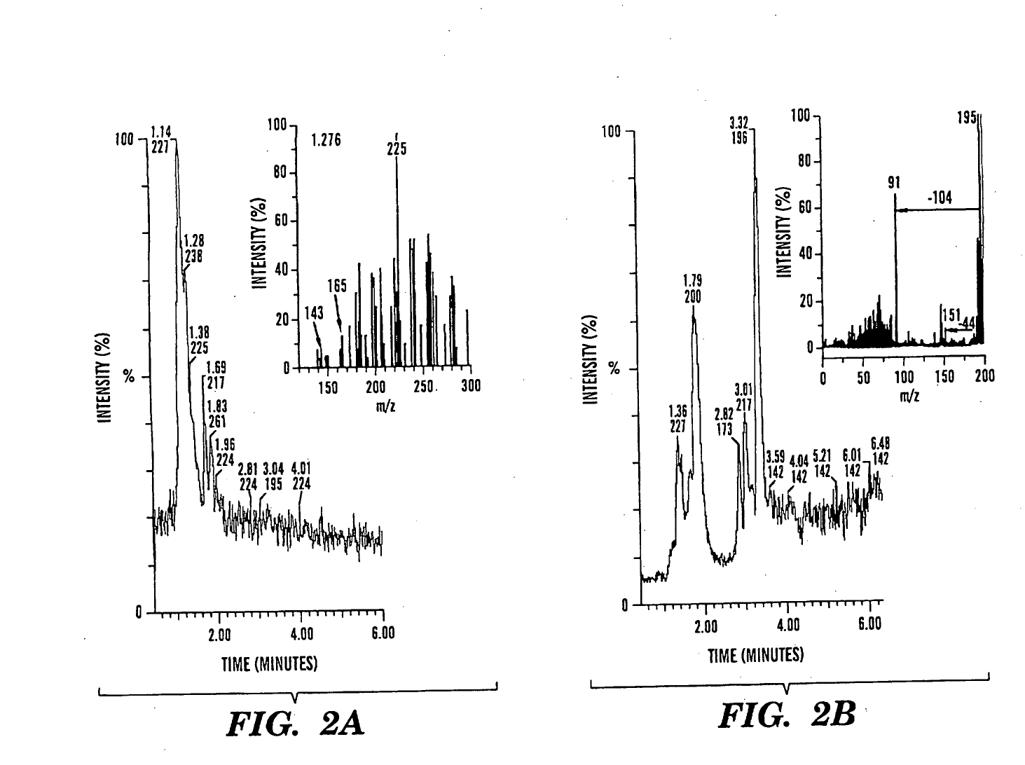

The reported formation of acrylamide in heated aqueous solutions containing asparagine and glucose was confirmed by RP-HPLC. As multiple peaks were observed with absorbance detection, samples were also analyzed by LC/MS. For these analyses samples needed to be concentrated. This sample concentration caused acrylamide to dimerize, it was detected under the peak at 1.28 min as m/z 143 (2M+H) and m/z 165 (2M+Na) (FIG. 2A, inset). When equimolar amounts of glucose, asparagine were heated in the presence of cysteine, the elution profile changed markedly, with a major peak eluting at 3.32 min (FIG. 2B). This material represented cysteine-adducted acrylamide, S-(3-amino-3-oxopropyl) cysteine as assessed by PSD-MS of m/z 195 (FIG. 2B, inset). Losses of m/z −104 and −44, corresponding to S-(3-amino-3-oxopropyl), formamide and/or carboxyl elimination were observed, consistent with cysteine-adducted acrylamide as the source material. In contrast, no adduct formation was observed when the known carbonyl-reactive hydrazine compound aminoguanidine was included.

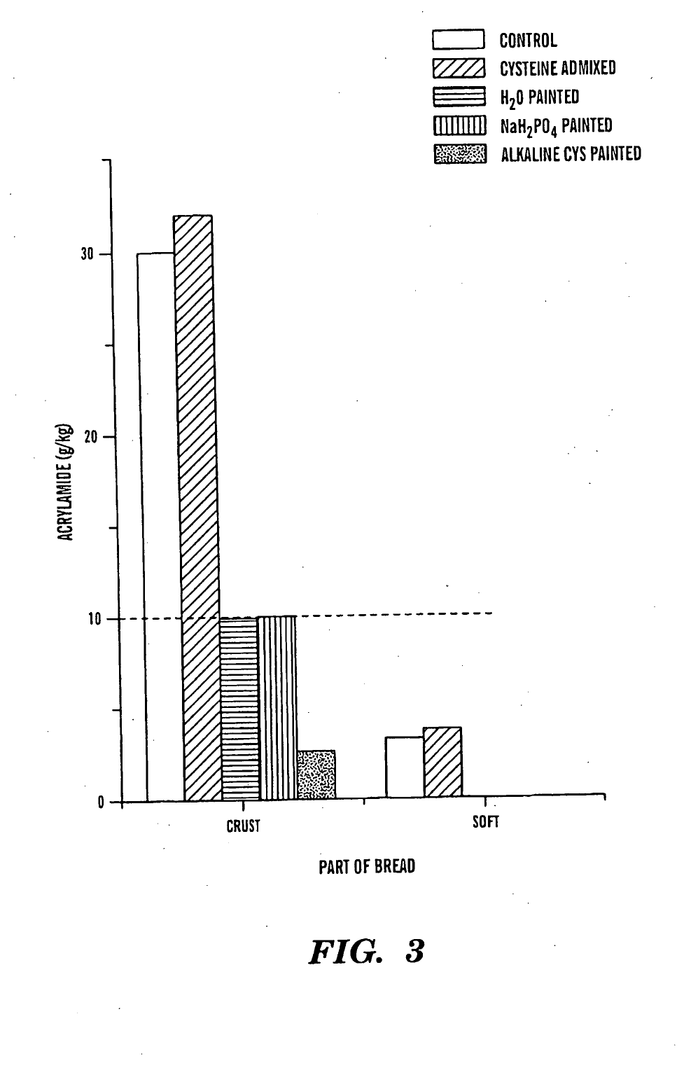

Having demonstrated that acrylamide reacts with cysteine at neutral pH in solution, cysteine hydrochloride, dissolved in water, was admixed to dough and the acrylamide content in the baked bread determined for crust and soft bread separately (FIG. 3).

Acrylamide was detected predominantly in the crust (30 μg/kg), with only very low levels (˜3 μg/kg) in soft bread. Admixing cysteine to the dough did not reduce acrylamide levels in either crust or soft bread. The large molar excess of cysteine over acrylamide should have driven adduct formation if the conditions had been permissible for adduct formation. As nucleophilic addition of sulfhydryl compounds to alkenes is favored at a basic pH, cysteine was painted onto the dough as aqueous basic solution. Surface application of cysteine reduced free acrylamide levels in the crust to 3 μg/ml. Painting the crust with water or a solution of monobasic sodium phosphate also reduced crust acrylamide but to a lesser extent.

### Discussion

Following our observation that acrylamide is formed primarily in the browned crust of bread, we tested whether its formation could be limited by acidification of the surface of the dough. Painting dough with water somewhat protected the surface from heat due to evaporation, thereby somewhat reducing acrylamide levels. Acrylamide formation does not occur in heated acidic aqueous solutions of asparagine and glucose because of the Schiff base is not stable at an acidic pH (15). However, acidifying dough by paining it with monobasic sodium phosphate did not reduce acrylamide levels in the crust beyond the decrease associated with wetting the surface. The reason why acidification did not limit acrylamide formation is not clear but may lie in the insufficient strength of the acid sodium phosphate.

Trapping acrylamide by admixing cysteine to dough did not reduce acrylamide, likely because the pH did not allow adduct formation to occur. However, when cysteine was painted onto the dough as a solution made mildly basic in the presence of dibasic sodium phosphate, acrylamide levels in the crust were greatly reduced (FIG. 3). This is consistent with the thiol groups having a pKₐ˜8 and hence requiring slightly alkaline pH for nucleophilic addition to alkenes. The reaction product generated in the course of acrylamide trapping, a side-chain modified amino acid is not likely to be toxic to man.

Others have reported that addition of free amino acids (140 mmol/kg glutamine or glycine) to homogenized potato slurry reduced acrylamide content of up to 90% (23) but it was not established whether this decrease was caused by competing reactions or covalently binding of acrylamide. Applying solutions of amino acids to the surface of foods for heat processing could well be an alternative way of preventing accumulation of free acrylamide.

While cysteine application limits free acrylamide in bread making, which based on our experiments in solution is likely caused by trapping of acrylamide, it is also possible that thiol agents may prevent formation of acrylamide by reacting with the intermediate imines I & II (FIG. 1).

The method described herein has the potential to limit free acrylamide in other heat-processed food products such as biscuits, flied potatoes, chips and fries as well. Breads, the main source of dietary acrylamide intake, and these other sources of acrylamide account for ˜70% of dietary intake (20). The simple and safe application of cysteine in baking of bread and the preparation of other starchy heat-processed foods substantially reduces overall dietary acrylamide intake and thereby limits potential harmful effects of acrylamide exposure.

The references cited herein and throughout the specification are incorporated herein by reference in their entirety.

### REFERENCES

1. FDA/CFSAN—Exploratory data on Acrylamide in Foods. http://www.cfsan.fda.gov 2003.
2. Dearfield, K. L.; Douglas, G. R.; Ehling, U. H.; Moore, M. M.; Sega, G. A.; Brusick, D. J. Acrylamide: a review of its genotoxicity and an assessment of heritable genetic risk. Mutat. Res 1995, 330, 71-99.
3. Sumner, S. C.; Fennell, T. R.; Moore, T. A.; Chanas, B.; Gonzalez, F.; Ghanayem, B. I. Role of cytochrome P450 2E1 in the metabolism of acrylamide and acrylonitrile in mice. Chem Res Toxicol. 1999, 12, 1110-1116.
4. Gamboa, d. C.; Churchwell, M. I.; Hamilton, L. P.; Von Tungeln, L. S.; Beland, F. A.; Marques, M. M.; Doerge, D. R. DNA adduct formation from acrylamide via conversion to glycidamide in adult and neonatal mice. Chem Res Toxicol. 2003, 16, 1328-1337.
5. von Muhlendahl, K. E.; Otto, M. Acrylamide: more than just another food toxicant? Eur. J Pediatr 2003, 162, 447-448.
6. Mucci, L. A.; Dickman, P. W.; Steineck, G.; Adami, H. O.; Augustsson, K. Dietary acrylamide and cancer of the large bowel, kidney, and bladder: absence of an association in a population-based study in Sweden. Br J Cancer 2003, 88, 84-89.
7. Hagmar, L.; Tornqvist, M. Inconclusive results from an epidemiological study on dietary acrylamide and cancer. Br J Cancer 2003, 89, 774-775.
8. Sorgel, F.; Weissenbacher, R.; Kinzig-Schippers, M.; Hofmann, A.; Illauer, M.; Skott, A.; Landersdorfer, C. Acrylamide: increased concentrations in homemade food and first evidence of its variable absorption from food, variable metabolism and placental and breast milk transfer in humans. Chemotherapy 2002, 48, 267-274.
9. Sickles, D. W.; Brady, S. T.; Testino, A.; Friedman, M. A.; Wrenn, R. W. Direct effect of the neurotoxicant acrylamide on kinesin-based microtubule motility. J Neurosci. Res 1996, 46, 7-17.
10. LoPachin, R. M.; Ross, J. F.; Lehning, E. J. Nerve terminals as the primary site of acrylamide action: a hypothesis. Neurotoxicology 2002, 23, 43-59.
11. Mottram, D. S.; Wedzicha, B. L.; Dodson, A. T. Acrylamide is formed in the Maillard reaction. Nature 2002, 419, 448-449.
12. Stadler, R. H.; Blank, I.; Varga, N.; Robert, F.; Hau, J.; Guy, P. A.; Robert, M. C.; Riediker, S. Acrylamide from Maillard reaction products. Nature 2002, 419, 449-450.
13. Yaylayan, V. A.; Wnorowski, A.; Perez, L. C. Why asparagine needs carbohydrates to generate acrylamide. J Agric. Food Chem 2003, 51, 1753-1757.
14. Amrein, T. M.; Bachmann, S.; Noti, A.; Biedermann, M.; Barbosa, M. F.; Biedermann-Brem, S.; Grob, K.; Keiser, A.; Realini, P.; Escher, F.; Amado, R. Potential of acrylamide formation, sugars, and free asparagine in potatoes: a comparison of cultivars and farming systems. J Agric. Food Chem 2003, 51, 5556-5560.
15. Brown, R. Formation, occurrence and strategies to address acrylamide in food. http://www.cfsan.fda.gov/˜dms/acrybrow/sld019.htm 2003.
16. Bailey, E.; Farmer, P. B.; Bird, I.; Lamb, J. H.; Peal, J. A. Monitoring exposure to acrylamide by the determination of S-(2-carboxyethyl)cysteine in hydrolyzed hemoglobin by gas chromatography-mass spectrometry. Anal. Biochem 1986, 157, 241-248.
17. Bergmark, E.; Calleman, C. J.; He, F.; Costa, L. G. Determination of hemoglobin adducts in humans occupationally exposed to acrylamide. Toxicol. Appl Pharmacol 1993, 120, 45-54.
18. Bergmark, E. Hemoglobin adducts of acrylamide and acrylonitrile in laboratory workers, smokers and nonsmokers. Chem Res Toxicol. 1997, 10, 78-84.
19. Sumner, S. C.; Williams, C. C.; Snyder, R. W.; Krol, W. L.; Asgharian, B.; Fennell, T. R. Acrylamide: a comparison of metabolism and hemoglobin adducts in rodents following dermal, intraperitoneal, oral, or inhalation exposure. Toxicol. Sci 2003, 75, 260-270.
20. Mucci, L. A.; Dickman, P. W.; Steineck, G.; Adami, H. O.; Augustsson, K. Reply: Dietary acrylamide and cancer risk: additional data on coffee. Br J Cancer 2003, 89, 774-776.
21. Barber, D. S.; Hunt, J.; LoPachin, R. M.; Ehrich, M. Determination of acrylamide and glycidamide in rat plasma by reversed-phase high performance liquid chromatography. J Chromatogr. B Biomed Sci Appl 2001, 758, 289-293.
22. Musser, S. M. Detection and quantitation of acrylamide in foods. http://www.cfsan.fda.gov/˜dms/acrylamide.html 2003.
23. Rydberg, P.; Eriksson, S.; Tareke, E.; Karlsson, P.; Ehrenberg, L.; Tornqvist, M. Investigations of factors that influence the acrylamide content of heated foodstuffs. J Agric. Food Chem 2003, 51, 7012-7018.

We claim:

1. A method for reducing the level of acrylamide in a food product, comprising: (a) applying an acrylamide reduction agent in alkaline solution onto a food material before heat treating the food material; and (b) heat treating the food material to form the finished food product, wherein due to application of the acrylamide reduction agent in alkaline solution, the finished food product comprises reduced level of acrylamide compared to a product which has not been treated with the acrylamide reduction agent in alkaline solution before heating.

2. The method of claim 1, wherein the acrylamide reduction agent is a compound comprising a sulfhydryl group.

3. The method of claim 1, wherein the acrylamide reduction agent is selected from the group consisting of cysteine or glutathione.

4. The method of claim 1, wherein the alkaline solution is a dibasic phosphate solution having pH 8-pH 10.

5. The method of claim 1, wherein the alkaline solution is 0.1% to 10% dibasic sodium phosphate.

6. The method of claim 1, wherein the alkaline solution is 0.1% to 10% dibasic potassium phosphate.

7. The method of claim 1, wherein the alkaline solution is 1% dibasic sodium phosphate having pH 9.1.

8. The method of claim 1, wherein the alkaline solution is carbonate buffer solution having pH 9.2-pH 10.8.

9. The method of claim 1, wherein the alkaline solution is a glycine/sodium hydroxide solution having pH 8.6-pH 12.8

10. The method of claim 1, wherein the acrylamide reduction agent is applied to the surface of the food product.

11. The method of claim 1, wherein the food product is selected from the group consisting of crackers, breads, toaster pastries, cookies, danish, croissant, tarts, pie crusts, pastries, muffins, brownies, sheet cakes, donuts, snack foods, flours, mixes, refrigerated doughs, frozen foods, bagels, breakfast cereals, biscuits, French fries, vegetables, taco shells, flour and corn tortillas, corn masa, hash browns, mashed potatoes, potato chips, processed potato foods, toast, grilled sandwiches, crepes, wontons, dumplings, pancakes, waffles, batters, pizza crust, rice, nut-based foods, fruit, coffee beans, cocoa beans, hush puppies, alcoholic beverages, meat products, animal food.
